(19) United States
(12) Patent Application Publication
(10) Pub. No.: US 2026/0245438 A1
(43) Pub. Date: Aug. 20, 2026

(54) RESTAURANT AVAILABILITY LIGHT ASSEMBLY OR DINING GLOW LIGHT

(71) Applicant: Ken Fewell, Chicago, IL (US)

(72) Inventor: Ken Fewell, Chicago, IL (US)

(21) Appl. No.: 19/543,920

(22) Filed: Feb. 19, 2026

Related U.S. Application Data
(60) Provisional application No. 63/760,785, filed on Feb. 20, 2025.

(51) Int. Cl. G08B 5/36; F21S 9/02; F21V 21/06; F21V 23/04; F21W 111/10; F21Y 113/13; F21Y 115/10; G08B 5/22

(52) U.S. Cl. CPC G08B 5/36; F21S 9/02; F21V 21/06; F21V 23/0485; G08B 5/225; F21W 2111/10; F21Y 2113/13; F21Y 2115/10

(57) ABSTRACT

A restaurant availability light assembly includes first color light emitting diode (LED) assemblies configured to emit a first color light when activated; a first transparent covering configured to provide protection for the first color LED assemblies and to allow the first color light to be visible when activated; second color LED assemblies configured to emit a second color light when activated; a second transparent covering configured to provide protection for the second color LED assemblies and to allow the second color light to be visible when activated; a rechargeable power supply to provide power to components; buttons coupled to one or more switching assemblies, the buttons configured to cause the one or more switching assemblies to turn on the restaurant availability light assembly in one mode and to select to activate the first color LED assemblies or the second color light assemblies in a second mode.

### RELATED APPLICATION

This non-provisional patent application claims priority to U.S. application Ser. No. 63/760,785, filed Feb. 20, 2025, entitled “RESTAURANT AVAILABILITY LIGHT ASSEMBLY OR DINING GLOW LIGHTNTILATION FILTER,” the entirety of which is hereby incorporated by reference.

### BACKGROUND

It is very difficult to have a business or personal conversation in a restaurant because waiters or servers are constantly interrupting during important time in the conversations. In addition, there are many times that you cannot get the waiter or server's attention to let them know you and your party are ready to order your drinks, dinner and/or desert, as well get the check. A device is needed to get the attention of the server and to also let the server know that a customer or patron want privacy.

### BRIEF DESCRIPTION OF THE DRAWINGS

A better understanding of the features, advantages and principles of the present disclosure will be obtained by reference to the following detailed description that sets forth illustrative embodiments, and the accompanying drawings of which:

FIG. 1 illustrates a drawing of a restaurant availability light assembly or dining glow light according to exemplary embodiments;

FIG. 2 illustrates a block diagram of a restaurant availability light assembly according to exemplary embodiments; and

FIG. 3 illustrates a drawing of a restaurant availability light assembly or dining glow light according to exemplary embodiments.

### DETAILED DESCRIPTION

The following detailed description and provides a better understanding of the features and advantages of the inventions described in the present disclosure in accordance with the embodiments disclosed herein. Although the detailed description includes many specific embodiments, these are provided by way of example only and should not be construed as limiting the scope of the inventions disclosed herein.

Described herein is a restaurant availability light assembly or dining glow light to allow a consumer to get or attract the attention of a waiter or server visually.

In exemplary embodiments, the restaurant availability lighting assembly or dining glow light 100 may include a green light assembly 105, reflective green light tape 110, a lighting assembly body 117, a power indicator 118, a charging port 115, a base or stand 120, an opening or hole in a top surface of the base or stand 125, a red light assembly 130, reflective red light assembly 135, and/or an on/off assembly 140. In exemplary embodiments, the red light assembly end 130 of the lighting assembly body 117 may be placed or inserted into the opening or hole 125 in a top surface of the base or stand 120 so that the green light assembly 105 may be seen by a waiter or server. In other words, the green light assembly 105 may be at the top of the lighting assembly body 117 and this means that the waiter or server knows that the diner or customer is ready for communication or talking. Conversely, in exemplary embodiments, if the customers or diners would like privacy, the customers or diners may place the green light assembly 105 lighting assembly body 117 into the opening or hole in the top surface of the base or stand and have the red light assembly 135 at a top of the lighting assembly 100. The restaurant availability light assembly or dining glow light 100 includes green lighting and red lighting because they are universally recognized as go and stop (or conversely, yes and no). Other colors may be utilized in certain circumstances (e.g., as if a restaurant has two main colors in its design and they indicate one color is for availability and they would like service and the other color is for peace and quiet and not to be bothered). In some implementations, the green light assembly 105 may be located above the green reflective tape assembly 110 on the lighting assembly body (when the restaurant availability light assembly is projecting a green light and availability. In these embodiments, the green reflective tape assembly 110 may be located above the on-off assembly 140 on the lighting assembly body 117 to provide easier access for the user. In these embodiments, the on-off assembly 140 may be located above the charging port or assembly 115. In these embodiments, the charging port or assembly 115 may be located above the red reflective tape assembly 135 on the lighting assembly body 117. In these embodiments, the red reflective tape assembly 135 may be located above the red light assembly 130. The order of the assemblies or sections of the light assembly 117 are in opposite order when the red light is the top section or part of the restaurant availability lighting assembly or dining glow light 100 and the customer or diner is indicating that he or she would like privacy.

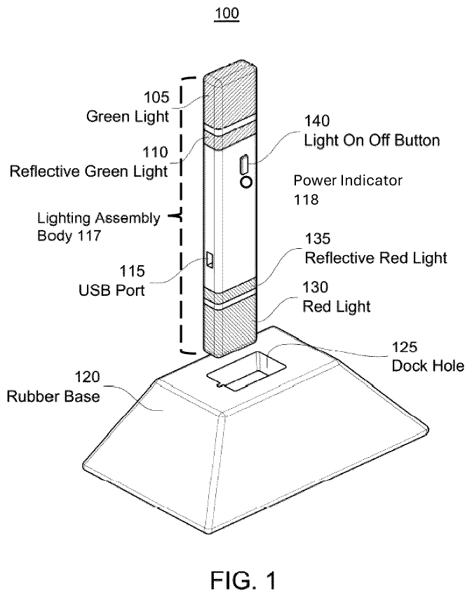

In exemplary embodiments, the restaurant availability light assembly or dining glow light 100 includes an on-off assembly 140 to activate or deactivate (e.g., turn on or off the restaurant availability light assembly and/or specifically the red light assembly 130 and/or the green light assembly 105). In the embodiments, illustrated in FIG. 1, the on-off assembly 140 may be located on an upper part of the lighting assembly body 117 for easy accessibility. In other embodiments, other locations may be utilized for the on-off assembly 140. In exemplary embodiments, a switch may be utilized as an on-off assembly 140. In alternative embodiments, dials may be utilized as an off-off assembly 140. In other embodiments, a contact switch in the lighting assembly body 117 (on a bottom side of the body) may be activated when placed in the base or stand 120. In exemplary embodiments, the lighting assembly body 117 may include a power indicator 118. In exemplary embodiments, the power indicator 118 may be located by the on-off assembly so that a user or customer may be aware when the restaurant availability lighting assembly is turned on or activated.

In exemplary embodiments, the green light assembly 105 may include a plurality of light emitting diodes (LEDs) (or one or more LEDs) and a cover assembly. In exemplary embodiments, the one or more LEDs may emit a green light. In these embodiments, the cover assembly may be transparent or sheer in order to allow the green light to be visible when the restaurant availability lighting assembly or dining glow light 100 is in use. In other embodiments, the one or more LEDs may emit a white light but a filter may be green so that light is presented as green light beams. In other embodiments, the LEDs may emit a white light and the cover assembly may be green and transparent so that a green light appears is projected from the green light assembly 105.

In certain outdoor environments (e.g., if a restaurant or eating establishment has an outdoor patio or is an outdoor restaurant), a LED light (whether green or red may not be visible. In these embodiments, a reflective green tape 110 may be wrapped around the lighting assembly body 117 (e.g., an entire surface circumference of the body 117) to allow a green light to be seen from in any environment. In other words, the reflective green tape 110 may be a backup to the green light assembly and if this is showing on the top of the restaurant availability lighting assembly or dining glow light 100, then the customer or diner would like service and is open to a visit by the waiter/waitress or server.

In exemplary embodiments, the red light assembly 130 may include a plurality of light emitting diodes (LEDs) and a cover assembly. In exemplary embodiments, the LEDs may emit a red light. In these embodiments, the cover assembly may be transparent or sheer in order to allow the red light to be visible when the restaurant availability lighting assembly is in use. In other embodiments, the LEDs may emit a white light but a filter may be red so that light is presented as red light beams or a red color. In other embodiments, the LEDs may emit a white light and the cover assembly may be red and transparent so that a red light is projected from the red light assembly 130.

In certain outdoor environments (e.g., if a restaurant or eating establishment has an outdoor patio or is an outdoor restaurant), a LED light (e.g. a red LED light) may not be visible to the server (or waitress/waiter). In these embodiments, a reflective red tape 135 may be wrapped around the lighting assembly body 117 (e.g., an entire surface circumference of the body 117) to allow a red light to be seen from any angle in an environment (even if outdoors). In other words, the reflective red tape 135 may be a backup to the red light assembly 130 and if this is showing on the top of the restaurant availability lighting assembly 100, then the customer or diner would like to be left alone and is open to a visit by the waiter/waitress or server.

In exemplary embodiments, the restaurant availability light assembly or dining glow light 100 may include a charging port 115 to charge and/or provide power to a rechargeable battery or power source (not shown) in the light assembly. In some implementations, this may be a USB-C, a USB-A, a USB-B or other type of charging port and may have a cable inserted into the charging port 115 to provide power from the external source. In exemplary embodiments, the charging port 115 may provide power directly to the green light assembly 105 and/or the red light assembly 130 (and turned on and off via the on/off assembly 140). In some implementations, other components may be present in the restaurant availability light assembly or dining glow light 100 and a printed circuit board (not shown) may be located in the restaurant availability light assembly or dining glow light 100. In these embodiments, the printed circuit board may provide structure and/or mounting to certain components. In exemplary embodiments, the rechargeable battery may be coupled or connected to the printed circuit board (which may be coupled or connected to the other components and/or the green lighting assembly 105 and/or the red light assembly 130.

Dimensions of the restaurant availability lighting assembly or dining glow light 100 may be as follows. In exemplary embodiments, the restaurant availability lighting assembly or dining glow light 100 may be 4 inches in height. In other embodiments, the restaurant availability lighting assembly or dining glow light 100 may range from 2 inches tall to 8 inches tall. In exemplary embodiments, the restaurant availability lighting assembly or dining glow light 100 may be 3/4 inch wide. The width is measured across the front part of lighting assembly body 117 where the front part includes the on-on assembly 140. In exemplary embodiments, the restaurant availability lighting assembly or dining glow light 100 may range in width from ½″ inch to 1.5 inches. In exemplary embodiments, the restaurant availability lighting assembly 100 may have a thickness of ¼ inches. This is the dimension that has a USB-C port charging assembly located on it. In exemplary embodiments, the restaurant availability lighting assembly or dining glow light 100 may have a thickness ranging from ⅛^{th} inch wide to ½ inch wide.

In exemplary embodiments, the reflective green light tape 110 and/or the reflective red light tape 135 may have a height of 2 millimeters (measured from top to bottom). In exemplary embodiments, the reflective green light tape 110 and/or the reflective red light tape 135 may have a height ranging from 1 millimeter to 6 millimeters.

In exemplary embodiments, the green light assembly 105 and/or the red light assembly 130 may have a height of ½ inches. In exemplary embodiments, the green light assembly 105 and/or the red light assembly 130 may have a height ranging from ¼ inch to 1 inch.

In exemplary embodiments, the base or stand 120 may be made of rubber or a material that may stick to a surface and provide stability for the lighting assembly body 117. In exemplary embodiments, the base or stand 120 may be 2 inches in width across, 1 inch in depth and ½ inch in height. In exemplary embodiments, the base or stand 120 may have an opening 125 that is ½ inch to place the lighting assembly body into. In exemplary embodiments, the base or stand 120 may be made of a rigid or hard plastic with an adhesive on the bottom. In exemplary embodiments, a width of a base or stand may range in width from 1 inch to three inches, a depth of a base or stand 120 may range from 0.5 to 1.5 inches in depth, and the height of the base or stand 120 may range from ¼^{th} inch to ¾th inches. In exemplary embodiments, the opening 125 may range from 0.25 to 075 inches.

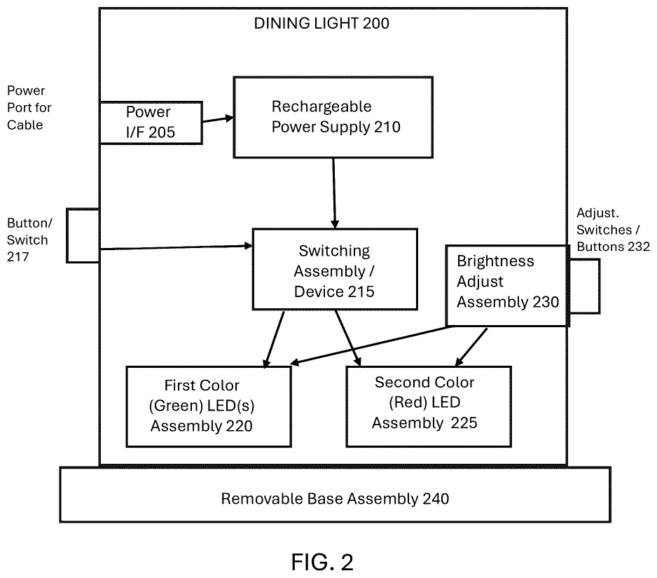

FIG. 2 illustrates a block diagram of a restaurant availability light assembly according to exemplary embodiments. In exemplary embodiments, the restaurant availability light assembly 200 may include one or more power interfaces or ports 205, one or more rechargeable power supplies 210, one or more button/switches 217, one or more switching assemblies or devices 215, one or more adjustment switches or buttons 232, and/or one or more brightness adjustment assemblies 230. In exemplary embodiments, the restaurant availability light assembly may also include a first color LED assembly 220, which may be a green LED assembly, and a second color LED assembly 225, which may be a red LED assembly. In exemplary embodiments, the restaurant availability light assembly 200 may be inserted into and/or detachable from a base assembly 240. In exemplary embodiments, the one or more power interfaces 205 may receive power from an external power source. In some embodiments, the external power source may be a wall outlet and/or an inductive charging assembly, and the input port may be a surface that may receive power from the inductive charging assembly. In examplary embodiments, the external power source may be an AC wall outlet and DC power adapter that provides power through a USB-A, USB-B, USB-C, Mini-USB or Micro-USB power cable or interface, and the one or more power interfaces 205 may be a USB-A, USB-B, USB-C, mini-USB or Micro-USB power interface. In exemplary embodiments, the one or more power interfaces may be coupled and/or connected to the one or more rechargeable power supplies 210 to provide DC power to the one or more rechargeable power supplies 210. It is important that the restaurant availability light assembly 200 is rechargeable and not be attached to a power cord at all times because these devices will be on a number of restaurant tables and not all tables will have power outlets available. The portability of the restaurant availability light assembly 200 is also important because these assemblies will be moved around the table and/or around the restaurant or dining established.

In exemplary embodiments, the rechargeable power supply 210 may provide power to components in the restaurant availability light assembly 200 including, but not limited to, the one or more switching assemblies or devices 215, the one or more brightness adjustment assemblies 230, the one or more first color LED assemblies 220 and/or the one or more second color LED assemblies 225. In exemplary embodiments, the one or more buttons or switches 217 may be coupled and/or connected to the one or more switching assemblies or devices 215 and may turn on or off the restaurant availability light assembly 200. In exemplary embodiments, the one or more switching assemblies/devices 215 may be coupled and connected to the first color (green) LED assemblies 220 and/or the second color (red) LED assemblies. In exemplary embodiments, the same button or switch 217 may be briefly pressed to toggle the one or more switching assemblies or devices 215 between the first color (green) LED assembly 220 and/or the second color (red) LED assembly 225. In exemplary embodiments, a green or first color light may be indicating service requested and a red or second color light may be indicating do not disturb. In other embodiments, a second button or switch 217 may be briefly pressed to toggle the one or more switching assemblies or device 215 between the between the first color (green) LED assembly 220 and/or the second color (red) LED assembly 225. In exemplary embodiments, the restaurant availability light assembly or dining light 200 may include a plurality of adjustment switches or buttons 232. In exemplary embodiments, the plurality of adjustment switches or buttons 232 may be coupled and/or connected to one or more brightness adjustment assemblies 230, which may be coupled and/or connected to the first color (e.g., green) LED assemblies 220 and/or the second color (e.g., red) LED assemblies 225. In exemplary embodiments, the one or more brightness adjustment assemblies 230 may reduce or increase a current or voltage to the first color LED assemblies 220 and/or the second color LED assemblies 225 in order to adjust the lighting output to four (4) different levels, ranging from soft to bright, for the first color LED assemblies 220 and/or the second color LED assemblies 225. In exemplary embodiments, the restaurant availability light assembly or dining light 200 may be inserted into a removable base assembly 240 and may be switched to putting a second end on the top (and away from the base assembly) when you are moving from one mode (e.g., green light) to another mode (e.g., red light).

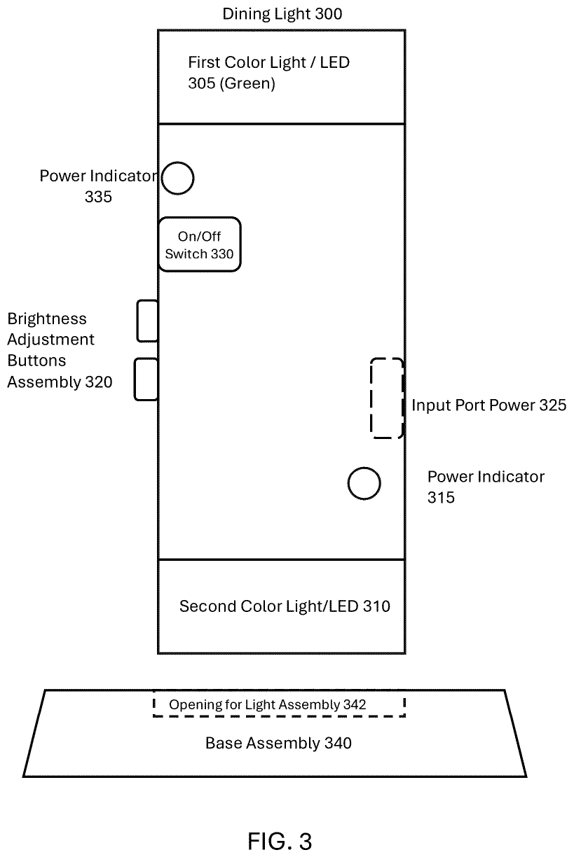

FIG. 3 illustrates a drawing of a restaurant availability light assembly or dining glow light according to exemplary embodiments. In exemplary embodiments, the base assembly 340 may include an opening 342 into which the light assembly or dining light 300 may be inserted. In exemplary embodiments, a first end (e.g., a top end in FIG. 3) may include a plastic or other transparent covering over one or more first color (e.g., green) LED assemblies 305. In exemplary embodiments, a second end (e.g., a bottom end in FIG. 3) may include a plastic or other transparent covering over one or more second color (e.g., red) LED assemblies 310. In exemplary embodiments, the second end is opposite to the first end. In exemplary embodiments, a reflective tape having the first color (not shown) may wrapped around a body of the light assembly or a dining light assembly 300 and may be spaced apart from the first color light or LED assemblies by a specified distance. In bright light or other light conditions, the inclusion of the reflective tape having the first color may enhance a visibility of the first color light or LED assemblies 305 in the dining light assembly 300. Similarly, in exemplary embodiments, a reflective tape having a second color (not shown) may be wrapped around a body of the light assembly or dining light 300 and may be spaced apart from the second color light or LED assemblies 310.

In exemplary embodiments, an on/off switch 330 may be positioned on a front surface of the restaurant availability light assembly or dining light. In exemplary embodiments, when the on/off switch 330 is activated or pressed for a set number of seconds (e.g., 2 or 3 seconds), the restaurant availability light assembly or dining light 300 may turn on and the power indicators 315 and 335 may indicate that the device 300 is turned on. In exemplary embodiments, a side of the restaurant availability light assembly or dining light 300 may include a power input port 325. This is where the restaurant availability light assembly or dining light 300 may receive power from an external power source. In exemplary embodiments, another side of the restaurant availability light assembly or dining light 300 may include two or more brightness adjustment buttons or assemblies 320. These may allow adjustment of intensity or brightness of the one or more first color LED or light assemblies 305 and/or the second color LED or light assemblies 310. In exemplary embodiments, a restaurant availability light assembly may include one or more first color light emitting diode (LED) assemblies configured to emit a first color light when activated; a first transparent covering configured to provide protection for the one or more first color LED assemblies and to allow the first color light to be visible when activated; one or more second color light emitting diode (LED) assemblies configured to emit a second color light when activated; a second transparent covering configured to provide protection for the one or more second color LED assemblies and to allow the second color light to be visible when activated; a rechargeable power supply to provide power to components of the restaurant availability light assembly; and one or more buttons coupled to one or more switching assemblies, the one or more buttons configured to cause the one or more switching assemblies to turn on the restaurant availability light assembly in one mode and to select to activate the one or more first color LED assemblies or the one or more second color light assemblies in a second mode. In exemplary embodiments, the one or more first color LED assemblies, one or more second color LED assemblies, the rechargeable power supply and the one or more switching assemblies are positioned inside a body portion of the restaurant availability light assembly. In exemplary embodiments, the body portion of the restaurant availability light assembly are inserted into an opening of a base assembly to allow the restaurant availability light assembly to stand and rise in a vertical direction. In exemplary embodiments, the one or more buttons are located on a front side of the body portion of the restaurant availability light assembly.

In exemplary embodiments, the first transparent covering is positioned on an outside surface of a top portion of the body portion and the second transparent covering is positioned on an outside surface of a bottom portion of the body portion. In exemplary embodiments, the restaurant availability light assembly includes additional buttons or switches coupled to one or more lighting adjustment assemblies, the additional buttons or switches configured to cause the one or more lighting adjustment assemblies to adjust an intensity of light emitted from the one or more first color LED assemblies or the one or more second color LED assemblies. In exemplary embodiments, the additional buttons or switches are positioned on a second side of the body portion of the restaurant availability light assembly and the one or more lighting adjustment assemblies are positioned inside the body portion. In exemplary embodiments, the body portion has a height ranging from three to five inches, has a width across ranging from ½ inch to 1.5 inches wide, and a depth ranging from ⅛^{th} inches to ½ inches. In exemplary embodiments, the restaurant availability light assembly further includes a reflective first color tape wrapped around a top portion of the body portion and adjacent to the one or more first color LED assemblies and a reflective second color tape wrapped around a second portion of the body section and adjacent to the one or more second color LED assemblies. In exemplary embodiments, the one or more first color LED assemblies and first transparent covering or the one or more second color LED assemblies and second transparent covering have a height ranging from ¼ inches to ¾ inches.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and shall have the same meaning as the word “comprising.

The processor as disclosed herein can be configured with instructions to perform any one or more steps of any method as disclosed herein.

As used herein, the term “or” is used inclusively to refer items in the alternative and in combination.

As used herein, characters such as numerals refer to like elements.

Embodiments of the present disclosure have been shown and described as set forth herein and are provided by way of example only. One of ordinary skill in the art will recognize numerous adaptations, changes, variations and substitutions without departing from the scope of the present disclosure. Several alternatives and combinations of the embodiments disclosed herein may be utilized without departing from the scope of the present disclosure and the inventions disclosed herein. Therefore, the scope of the presently disclosed inventions shall be defined solely by the scope of the appended claims and the equivalents thereof.

1. A restaurant availability light assembly, comprising:
one or more first color light emitting diode (LED) assemblies configured to emit a first color light when activated;
a first transparent covering configured to provide protection for the one or more first color LED assemblies and to allow the first color light to be visible when activated;
one or more second color light emitting diode (LED) assemblies configured to emit a second color light when activated;
a second transparent covering configured to provide protection for the one or more second color LED assemblies and to allow the second color light to be visible when activated;
a rechargeable power supply to provide power to components of the restaurant availability light assembly; and
one or more buttons coupled to one or more switching assemblies, the one or more buttons configured to cause the one or more switching assemblies to turn on the restaurant availability light assembly in one mode and to select to activate the one or more first color LED assemblies or the one or more second color light assemblies in a second mode.

2. The restaurant availability light assembly of claim 1, wherein the one or more first color LED assemblies, one or more second color LED assemblies, the rechargeable power supply and the one or more switching assemblies are positioned inside a body portion of the restaurant availability light assembly.

3. The restaurant availability light assembly of claim 2, wherein the body portion of the restaurant availability light assembly are inserted into an opening of a base assembly to allow the restaurant availability light assembly to stand and rise in a vertical direction.

4. The restaurant availability light assembly of claim 2, wherein the one or more buttons are located on a front side of the body portion of the restaurant availability light assembly.

5. The restaurant availability light assembly of claim 2, wherein the first transparent covering is positioned on an outside surface of a top portion of the body portion and the second transparent covering is positioned on an outside surface of a bottom portion of the body portion.

6. The restaurant availability light assembly of claim 2, further including additional buttons or switches coupled to one or more lighting adjustment assemblies, the additional buttons or switches configured to cause the one or more lighting adjustment assemblies to adjust an intensity of light emitted from the one or more first color LED assemblies or the one or more second color LED assemblies.

7. The restaurant availability light assembly of claim 6, wherein the additional buttons or switches are positioned on a second side of the body portion of the restaurant availability light assembly and the one or more lighting adjustment assemblies are positioned inside the body portion.

8. The restaurant availability light assembly of claim 2, wherein the body portion has a height ranging from three to five inches, has a width across ranging from ½ inch to 1.5 inches wide, and a depth ranging from ⅛^{th} inches to ½ inches.

9. The restaurant availability light assembly of claim 2, further including a reflective first color tape wrapped around a top portion of the body portion and adjacent to the one or more first color LED assemblies and a reflective second color tape wrapped around a second portion of the body section and adjacent to the one or more second color LED assemblies.

10. The restaurant availability light assembly of claim 2, wherein the one or more first color LED assemblies and first transparent covering or the one or more second color LED assemblies and second transparent covering have a height ranging from ¼ inches to ¾ inches.
